(19) United States
(12) Patent Application Publication
(10) Pub. No.: US 2005/0153718 A1
(43) Pub. Date: Jul. 14, 2005

(54) Apparatus, system and method of delivering a text message to a landline telephone

(75) Inventor: Blaine H. Dolph, Western Springs, IL (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/756,938

(22) Filed: Jan. 14, 2004

(51) Int. Cl. H04Q 7/00

(52) U.S. Cl. 455/466

(57) ABSTRACT

A system, apparatus and method of delivering a text message from a digital telephone to a landline telephone are provided. When a text message is sent from a digital telephone to a landline telephone, the message is gone first to an intermediary device. There, an audio file is made out of the text message. Once done, the intermediary device places a call to the landline telephone. When the call is answered by either a person or an answering machine, the intermediary plays the audio file. Hence, the text message is delivered orally. If the landline is a digital telephone both the text message and the audio file may be downloaded to the landline telephone. If the landline telephone further has a screen to display text, either the text version of the message or the speech version of the message may be retrieved.

### BACKGROUND OF THE INVENTION

1. Technical Field

The present invention is directed to telephones. More specifically, the present invention is directed to an apparatus, system and method of delivering a text message to a landline telephone.

2. Description of Related Art

A key feature of cellular telephones is text messaging, which is also known as Short Message Service (SMS). SMS is the transmission of short text messages to and from a cellular telephone, fax machine and/or IP address. The messages must be no longer than 160 alpha-numeric characters and contain no images or graphics.

Once a message is sent, it is received by a Short Message Service Center (SMSC), which will then get it to the appropriate cellular device. To do this, the SMSC sends an SMS request to a home location register (HLR) to find the cellular device. Once the HLR receives the request, it will respond to the SMSC with the status of the cellular device (e.g., active or inactive as well as the geographic location of the cellular device). If the response is “inactive”, the SMSC will hold onto the message. When the device becomes active, the HLR will send an SMS notification to the SMSC, and the SMSC may then attempt delivery. The SMSC transfers the message in a Short Message Delivery point-to-point format to the servicing system. The system pages the device, and if it responds, the message gets delivered. The SMSC may then receive verification that the message was received then categorizes the message as “sent” and will not attempt to send again.

Presently, a text message cannot be sent to a landline telephone. What is needed then is a system, apparatus and method of sending a text message to a landline telephone.

### SUMMARY OF THE INVENTION

The present invention provides a system, apparatus and method of delivering a text message to a landline telephone. When a text message is sent from a digital telephone to a landline telephone, the message is gone first to an intermediary device. There, an audio file is made out of the text message. Once done, the intermediary device places a call to the landline telephone. When the call is answered by either a person or an answering machine, the intermediary plays the audio file. Hence, the text message is delivered orally. If the landline is a digital telephone both the text message and the audio file may be downloaded to the landline telephone. If the landline telephone further has a screen to display text, either the text version of the message or the speech version of the message may be retrieved.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a schematic block diagram of a telephone apparatus.

FIG. 2 depicts a first operating panel that may be used by the present invention.

FIG. 3 depicts a second operating panel that may be used by the present invention.

FIG. 4 is a flow chart of a process that may be used by an Short Messaging Service Center (SMSC).

FIG. 5 is a flowchart of a process that may be used by a bridge.

FIG. 6 is a flowchart of a process that may be used by either a digital landline telephone or a wireless telephone to retrieve messages.

### DETAILED DESCRIPTION OF THE PREFERRED EMBODIMENT

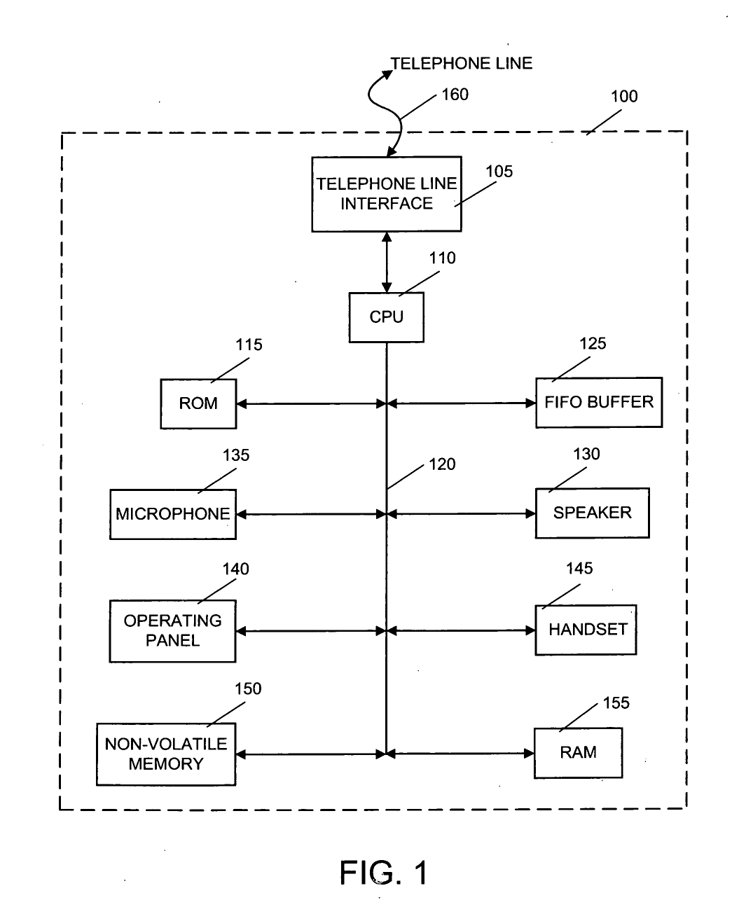

Turning to the figures, FIG. 1 depicts a schematic block diagram of a telephone apparatus 100. The telephone apparatus 100 is connected to a telephone line 160 through a telephone line interface 105. The telephone line 160 may be an antenna for those devices that are not landline connected (e.g., wireless telephones) to a telephone service provider. The telephone line interface 105 is connected to CPU 110. CPU 110 is connected to ROM 115, first-in, first-out (FIFO) buffer 125, speaker 130, microphone 135, operating panel 140, handset 145, non-volatile memory 150 and RAM 155 via a bus 120.

With the use of a software utility package stored in ROM 115, CPU 110 performs various functions. For example, the CPU 110 may send a ring tone to speaker 130 whenever the telephone line interface 105 detects a ring signal. Likewise, CPU 110 may send a busy tone to speaker 130 when the telephone line interface 105 detects a busy signal.

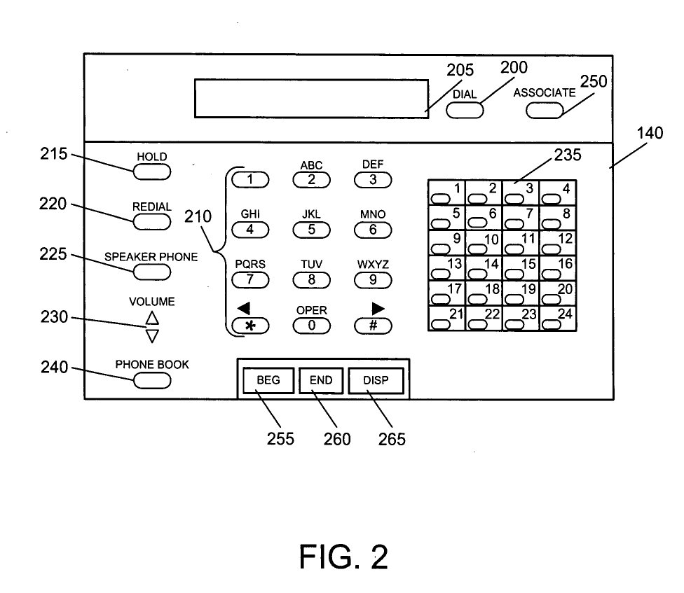

Furthermore, when a dial tone is detected, CPU 110 may send a dial tone to handset 145. If the CPU 110 detects that a speaker phone button (see FIG. 2) has been depressed, it may send the dial tone to speaker 130 instead of to handset 145. Microphone 135 allows a user to communicate with a person on the telephone without using the handset 145. Non-volatile memory 150 is used to store a phone book and FIFO buffer 125 is used to store the most recently dialed number for the redial feature.

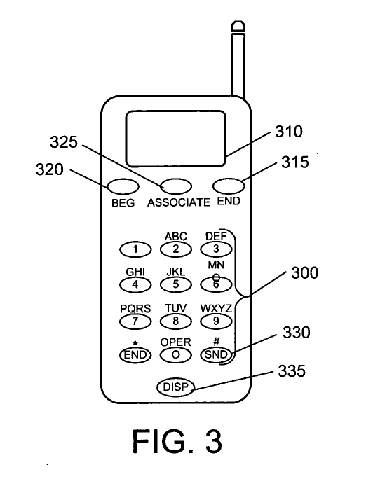

FIGS. 2 and 3 depict each a different operating panel 140. The operating panel in FIG. 2 may be used by a land-line telephone whereas that of FIG. 3 may be used by a wireless telephone. Both operating panels may contain similar functions. In order to simplify the disclosure of the invention, the functions included in the operating panels 140 will mostly be explained using FIG. 2. Furthermore, for a better understanding of the invention, FIG. 2 should be viewed in conjunction with FIG. 1.

The operating panel 140 contains hold button 215 that is used to put a person with whom the user is communicating on hold. Redial button 220 allows the user to redial a number that was previously dialed. Speaker phone button 225 in conjunction with microphone 135 allows the user to use the phone without the handset 145. Volume 230 allows a user to increase or decrease the volume of the sound from the speaker 130. Phone book button 240 allows access to telephone numbers that have been stored into non-volatile memory 150.

Speed dial pad 235 contains buttons 1, 2, 3 etc. that may be depressed to dial pre-programmed numbers. Dial pad 210 allows a user to dial numbers as well as to fill in the phone book 240 and to pre-program numbers for the speed dialing feature. Display 205 may be a liquid crystal display (LCD) on which numbers that are being dialed are displayed. If the phone has an integrated caller identification (ID) feature, the caller ID information may also be displayed on the LCD 205. When a telephone number is displayed on the LCD 205 and dial button 200 is depressed, the displayed number may be dialed to complete the call.

The method of speed dialing, redialing, entering numbers in phone books, retrieving numbers from phone books, using the speaker phone etc. is well known in the field and will not be further described. Thus, the rest of this disclosure will focus on the present invention.

The invention is an apparatus, system and method of sending a text message to a landline telephone. Using the operating panel 140 of either FIG. 2 or FIG. 3, a text message may be typed into the telephone. To do so, a user may have to first depress “begin” button 255 using keypad 210 of FIG. 2 (or “begin” button 320 of FIG. 3). To notify the system of the end of the message, “end” button 260 (or 315) may be depressed. “Associate” button 250 (or 325) may be used to associate the text message with a telephone number that will have been entered after the “end” button 260 has been depressed. After associating the text message with the number, “dial” button 200 (or “send” button 330) may be depressed to place the call.

If the message is being sent from a cellular phone to either another cellular telephone or to a landline telephone, the message may first be sent to an SMSC. The SMSC may then convert the message to an audio file before delivery. Particularly, the SMSC may use a text-to-speech software program (e.g., IBM Viavoice Text-To-Speech, Aldo's Text-to-Wave, TextSound, CoolSpeaking, JustSpeak, CoolSpeech etc.) to make an audio file out of the text message. After doing so, both the audio file and the text message may be sent to the target cellular telephone, if the number with which the message is associated is the number of a cellular telephone or the SMSC may autodial the landline telephone in order to deliver the message.

If the message is being sent from a landline telephone to either another landline telephone or a cellular telephone, the message may first be sent to a bridge. Just as in the case of the SMSC, the bridge may use a text-to speech software package to convert the message into an audio file. The audio file, including the telephone number with which the message is associated, as well as the text message may then be sent to the SMSC in the case where the message is to be delivered to a cellular telephone. If the message is to be sent to a landline telephone, the bridge may autodial the number to deliver the message.

When a message is to be delivered to a cellular telephone, the SMSC may deliver the text as customary. In addition, the audio file may simultaneously be downloaded into the telephone. In that case, both versions of the message (i.e., both the text message and the audio file) may be stored in RAM 155. To retrieve the audio message from the RAM 115, a user may have to assert “display” button 335 where a menu may be displayed on LCD 310. There, a user may be given an option to access either the text message or the audio file. If the user chooses the text message then the message may be displayed on LCD screen 315. If, instead, the user chooses the audio version of the message, the audio file may be played to the user. Note that, the telephone number from which the message originated as well as the time of delivery may be used to distinguish one message from another if there is more than one message stored in the telephone.

When the SMSC or the bridge autodials a landline telephone to deliver a message, if a person answers, the audio file version of the message may automatically be played to the person. If however, an answering machine answers, the oral version of the message may be recorded. In addition and as in the case of the cellular phone message delivery, both the audio file and the text message may also be downloaded into RAM 155. Thus, at anytime a user may retrieve the message either orally or textually from RAM 155 using the number from which the message originates as well as its delivery time. Note that the text message may not be retrieved or may not be downloaded to landline telephones that do not have an LCD screen (see LCD 205 of FIG. 2). Note also that after delivery, the bridge may email or send a message back to the originating device indicating the delivery time. The bridge, as well as the SMSC, must have at least one processor for processing code data and a storage device for storing the code data. It must also have some software intelligence to receive text messages, make audio files out of the text messages, call intended telephones and play the audio files etc.

The text message may be retrieved from a landline telephone with an LCD screen by scrolling through numbers from incoming calls that may have been stored in the system. This is akin to scrolling through numbers of a caller ID system. When a telephone number with which a message is associated is displayed on the LCD screen and the user pauses for more than a few seconds, the message may start to scroll from right to left on the LCD screen.

The invention is described using digital landline telephones. However, if the landline telephone is not digital, a text message may not be sent or received by the telephone. Further, the audio file may not be received by the telephone either. Thus, only the oral or speech version of the audio file may be played to a person who answers the phone or recorded by an answering machine when the SMSC or the bridge autodials the number of the telephone.

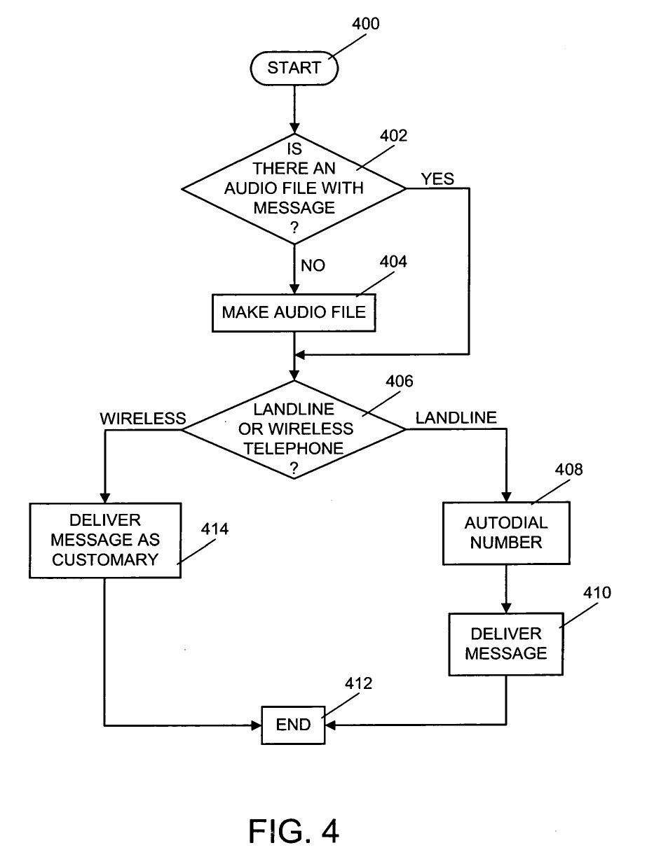

FIG. 4 is a flowchart of a process that may be used by an SMSC according to the present invention. The process starts when the SMSC receives a text-based message to be forwarded (step 400). Since, a bridge may make an audio file out of a text message before forwarding the message to an SMSC, the SMSC may check to determine whether the text message is accompanied with an audio file. If not, the SMSC may use a text-to-speech software to make an audio file out of the text message (steps 402, 404). Otherwise, the process may jump to step 406 where a check is made to determine whether the telephone to which the message is to be forwarded is a wireless telephone or a landline telephone. The number of the telephone may be used to make this determination. That is, certain ranges of numbers are dedicated for wireless telephone uses while the rest is for landline uses.

If it is determined that the telephone is a wireless telephone, then the text message may be delivered as customary. At that time, the audio file may be downloaded to the phone as well. Once that is done the process may end (steps 406, 414 and 412).

If it is determined that the telephone is a landline telephone, then the SMSC may autodial the number of the telephone. If a person answers, the audio file may be played to the person. If an answering machine answers, the audio message may be recorded. Further, if the landline telephone is digital, both the text message and the audio file may also be downloaded to the telephone for later use before the process ends (steps 406, 408, 410 and 412).

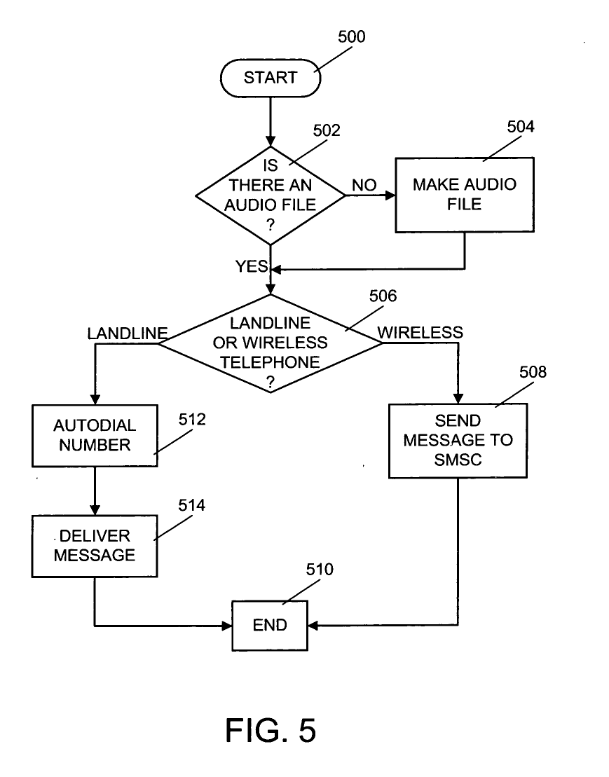

FIG. 5 is a flowchart of a process that may be used by a bridge according to the present invention. The process starts when the bridge receives a text-based message to be forwarded (step 500). Since, an SMSC may make an audio file out of a text message before forwarding the message to a bridge, the bridge may check to determine whether the text message is accompanied with an audio file. If not, the SMSC may use a text-to-speech software to make an audio file out of the text message (steps 502, 504). Otherwise, the process may go to step 506 where a check is made to determine whether the telephone to which the message is to be forwarded is a wireless telephone or a landline telephone. As mentioned above, the number of the telephone may be used to make this determination.

If it is determined that the telephone is a wireless telephone, then the text message and the audio file may be sent to the SMSC serving, the wireless telephone and the process ends (steps 508 and 510). If it is determined that the telephone is a landline telephone, then the bridge may autodial the number of the telephone. If a person answers, the audio file may be played to the person. If an answering machine answers, the audio message may be recorded. As mentioned above, if the landline telephone is digital telephone, both the text message and the audio file may also be downloaded to the telephone for later use before the process ends (steps 506, 512, 514 and 510).

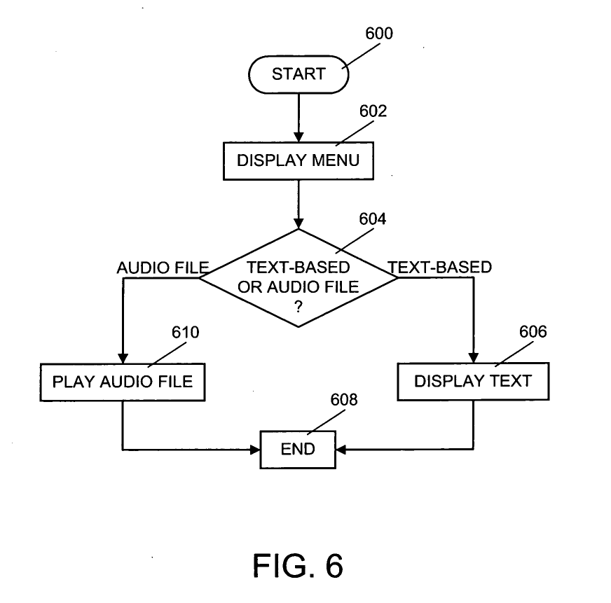

FIG. 6 is a flowchart of a process that may be used by a wireless telephone or a digital landline telephone to retrieve messages stored therein. The process starts when a user asserts “display” button 265 (FIG. 2) or 335 (FIG. 3). When that occurs a two-choice menu may be displayed. The choices may include “READ MESSAGE” or “LISTEN TO MESSAGE”. If the user chooses to read the message, the text message may be displayed. If the user chooses instead to listen to the message the audio file may be played to the user. Once the text is displayed or the audio file is played, the process may end. (steps 600-610).

The description of the present invention has been presented for purposes of illustration and description, and is not intended to be exhaustive or limited to the invention in the form disclosed. Many modifications and variations will be apparent to those of ordinary skill in the art. Thus, the embodiment was chosen and described in order to best explain the principles of the invention, the practical application, and to enable others of ordinary skill in the art to understand the invention for various embodiments with various modifications as are suited to the particular use contemplated.

1. A method of delivering a text message from a digital telephone to a landline telephone comprising:
sending the message from the digital telephone to an intermediary device, the intermediary device for:
making an audio file of the text message using a text-to-speech software module;
automatically placing a call to the landline telephone; and
playing the audio file when the call is answered.

2. The method of claim 1 wherein if the landline telephone is a digital telephone both the text message and the audio file are downloaded to the landline telephone.

3. The method of claim 2 wherein if the landline telephone includes a screen the downloaded text message is retrieved by displaying the text on the screen.

4. The method of claim 2 wherein the downloaded audio file message is retrieved by playing the audio file.

5. The method of claim 1 wherein the digital telephone is a wireless telephone.

6. The method of claim 1 wherein the digital telephone is a landline telephone.

7. A method of delivering a text message from a digital telephone to a wireless telephone comprising:
sending the message from the digital telephone to an intermediary device, the intermediary device for:
making an audio file of the text message using a text-to-speech software module; and
downloading the text message and the audio file to the wireless telephone when the wireless telephone is active.

8. The method of claim 7 wherein the downloaded audio file message is retrieved by playing the audio file.

9. The method of claim 7 wherein the digital telephone is a wireless telephone.

10. The method of claim 7 wherein the digital telephone is a landline telephone.

11. A computer program product on a computer readable medium for delivering a text message from a digital telephone to a landline telephone comprising:
code means for receiving the message when the message is sent from the digital telephone to an intermediary device;
code means for making an audio file of the text message using a text-to-speech software module;
code means for automatically placing a call to the landline telephone; and
code means for playing the audio file when the call is answered.

12. The computer program product of claim 11 wherein if the landline telephone is a digital telephone both the text message and the audio file are downloaded to the landline telephone.

13. The computer program product of claim 12 wherein if the landline telephone includes a screen the downloaded text message is retrieved by displaying the text on the screen.

14. The computer program product of claim 12 wherein the downloaded audio file message is retrieved by playing the audio file.

15. The computer program product of claim 11 wherein the digital telephone is a wireless telephone.

16. The computer program product of claim 11 wherein the digital telephone is a landline telephone.

17. A computer program product on a computer readable medium for delivering a text message from a digital telephone to a wireless telephone comprising:
code means for receiving the message when it is sent from the digital telephone to an intermediary device;
code means for making an audio file of the text message using a text-to-speech software module; and
code means for downloading the text message and the audio file to the wireless telephone when the wireless telephone is active.

18. The computer program product of claim 17 wherein the downloaded audio file message is retrieved by playing the audio file.

19. The computer program product of claim 17 wherein the digital telephone is a wireless telephone.

20. The computer program product of claim 17 wherein the digital telephone is a landline telephone.

21. An apparatus for delivering a text message from a digital telephone to a landline telephone comprising:
means for receiving the message when the message is sent from the digital telephone to an intermediary device;
means for making an audio file of the text message using a text-to-speech software module;
means for automatically placing a call to the landline telephone; and
means for playing the audio file when the call is answered.

22. The apparatus of claim 21 wherein if the landline telephone is a digital telephone both the text message and the audio file are downloaded to the landline telephone.

23. The apparatus of claim 22 wherein if the landline telephone includes a screen the downloaded text message is retrieved by displaying the text on the screen.

24. The apparatus of claim 22 wherein the downloaded audio file message is retrieved by playing the audio file.

25. The apparatus of claim 21 wherein the digital telephone is a wireless telephone.

26. The apparatus of claim 21 wherein the digital telephone is a landline telephone.

27. An apparatus for delivering a text message from a digital telephone to a wireless telephone comprising:
means for receiving the message when it is sent from the digital telephone to an intermediary device;
means for making an audio file of the text message using a text-to-speech software module; and
means for downloading the text message and the audio file to the wireless telephone when the wireless telephone is active.

28. The apparatus of claim 27 wherein the downloaded audio file message is retrieved by playing the audio file.

29. The apparatus of claim 27 wherein the digital telephone is a wireless telephone.

30. The apparatus of claim 27 wherein the digital telephone is a landline telephone.
